(19) United States
(12) Patent Application Publication
(10) Pub. No.: US 2025/0010940 A1
(43) Pub. Date: Jan. 9, 2025

(54) MECHANISM FOR PROPELLING HUMAN-POWERED VEHICLES BY MEANS OF LEVERS THAT PIVOT ON A HORIZONTAL AXIS AND/OR TWO PARALLEL AND SYMMETRICAL VERTICAL AXES

(71) Applicant: Mohamed Sadek BENTERKI, Gué de Constantine (DZ)

(72) Inventor: Mohamed Sadek BENTERKI, Gué de Constantine (DZ)

(21) Appl. No.: 18/711,769

(22) PCT Filed: Sep. 13, 2022
(86) PCT No.: PCT/DZ2022/050010

§ 371 Date: May 20, 2024

(30) Foreign Application Priority Data
Nov. 21, 2021 (DZ) DZ-2021-000716

(51) Int. Cl. B62M 1/30; B63H 16/08; B63H 16/18; B64C 31/04

(52) U.S. Cl. CPC B62M 1/30; B63H 16/14; B63H 16/18; B64C 31/04

(57) ABSTRACT

The present invention relates to a mechanism comprising a frame (10), levers (7), pedals (19,17,13), clutches (01), and/or freewheels, gears and/or pulleys, rotation shafts (8,9, 11, 14, 15), and/or push shafts levers (20) which convert the reciprocating pushing motion into a rotational motion of the different vehicles or whatever needs of driving force, by the muscular effort of the legs of at least one user in a vertical position (standing) and/or a user in a horizontal position (sitting) or even completely lying on the back or on the stomach in order to push the levers (7) which bounce back and forth around a horizontal axis (HX) and/or two parallel and symmetrical vertical axes (VX1 and VX2).

### TECHNICAL FIELD TO WHICH THE INVENTION RELATES

The present invention relates to a mechanism that converts the reciprocating thrust of levers with the muscular force of the legs into a circular motion to propel land vehicles, sea vehicles, light aircraft, sports equipment, electrical generators or anything that requires motive power.

### PURPOSE OF THE INVENTION

Increase the thrust of the vehicle, which reduces effort and increases its efficiency in terms of speed and time.
Reduce the consequences of fossil fuels on the economy and the environment.
Allow light aircraft and gliders to fly without:
   Combustion engine.
   Electric motor and heavy batteries required which increase the load of the aircraft.
   Towing of gliders by plane, car or other means used in this field.
Motivate individuals and groups to be physically active, which will benefit their health.
Opening of a new field for land and aeronautical team sports.

### STATE OF THE PRIOR ART

There are many inventions for vehicle propulsion by human power, and the closest to the current invention, which falls under the international classification (B62M 1/30 and B62M 1/24), include the American document (US20070085297A1), and most of them are similar and close in terms of performance and content, and one of its most important disadvantages is that it only depends on a horizontal axis (HX) around which levers rotate, and which imposes a position which makes the vehicle elevated and exposes it to strong air resistance which limits its efficiency and requires the user to make additional effort.

On the other hand, the present invention is characterized by the position of two parallel and symmetrical vertical axes (VX1 and VX2) where the user can be completely lying on the back or on the stomach, which reduces the height of the vehicle and thus weakens the air resistance facing the vehicle and its user, in order to provide better performance regarding the user's effort and to improve the travel and flow of the vehicle.

Also, the present invention is distinguished from the previous one by the methods of collecting the driving forces of the users on a horizontal axis (HX) and/or two parallel and symmetrical vertical axes (VX1 and VX2).

### BRIEF DESCRIPTION OF THE DRAWINGS

FIG. 1 Perspective view of the horizontal axis (HX) mechanism operated by a single user.

FIG. 2 Top view of the horizontal axis (HX) mechanism operated by a single user.

FIG. 3 Front view of the clutch (1) which consists of the following elements:

1—cams (3)

2—hard steel gear wheel (4) which fixes the clutch (1) to the rotation shaft

3—Cam cage (5)

4—Hard steel toothed collar (6) which fixes the lever (7) to the clutch (1)

FIG. 4 Side view of the clutch (1).

FIG. 5 Perspective view of the clutch (1).

FIG. 6 Perspective shape of the mechanism with two parallel and symmetrical vertical axes (VX1 and VX2), on which two levers operated by a user and two other levers operated by a group of users are installed.

FIG. 7 Front view of the mechanism with two parallel and symmetrical vertical axes (VX1 and VX2), on which two levers operated by a user and two other levers operated by a group of users are installed.

FIG. 8 Perspective shape of the mechanism with a horizontal axis (HX) which pivots around itself in reciprocating movement using six levers (7) coupled to the clutches (1) and the shaft (15) where the gear (02) is between a pair among them and the other levers are added in even numbers to the right and left of the gear (02) in one of the embodiments of mechanism for gathering the driving forces.

FIG. 9 Perspective shape of the mechanism with a horizontal axis (HX) which pivots around itself in reciprocating movement six levers (7) offset, parallel and adjustable in length, because the two levers (7) the longest of them are closer of the gear (02) on its sides and their pedals at the rear and therefore the pedals of the two shorter ones are at the front in order to be occupied by more than one user, who at the front pushes the two levers (7) the shortest and the last pushes the two longest of them in one of the embodiments of mechanism for gathering the driving forces.

FIG. 10 View of a side section of the front part of FIG. 1.

FIG. 11 View of a top section of the left part (side of the vertical axis VX2) for FIGS. 6 and 7.

FIG. 12 Perspective view of a glider operating with a mechanism with two parallel and symmetrical vertical axes (VX1 and VX2).

FIG. 13 Perspective view of a tricycle powered by a horizontal axis (HX) mechanism.

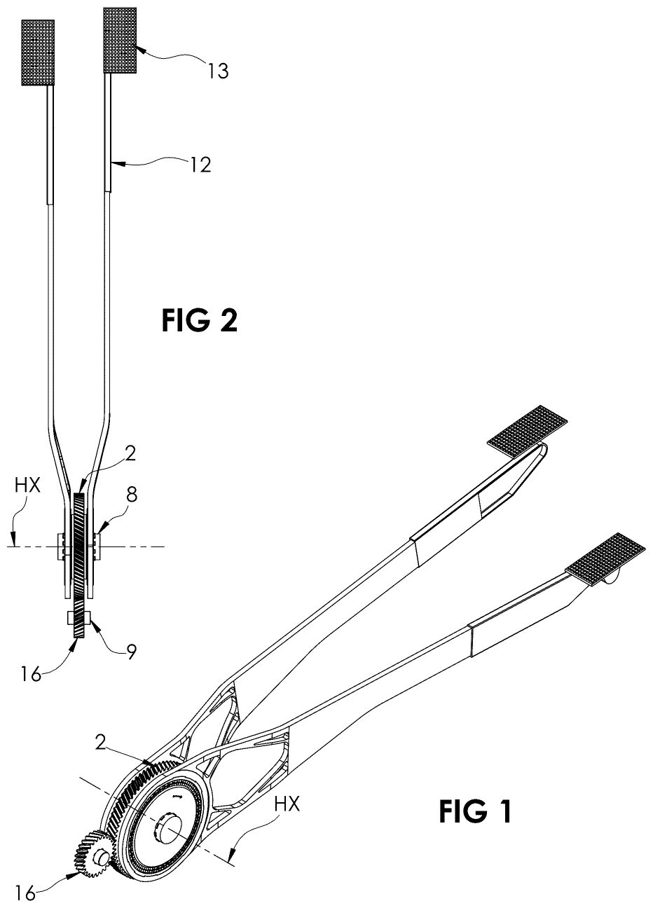

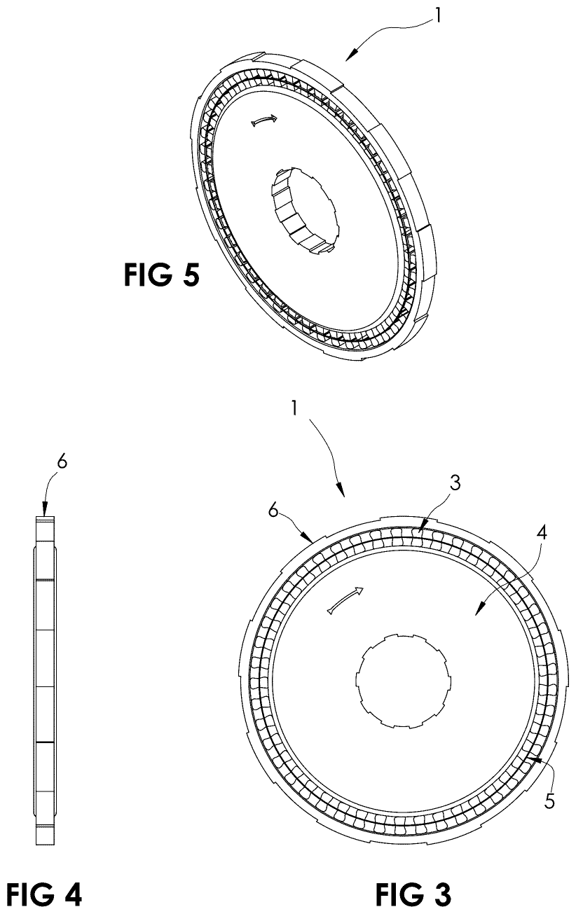

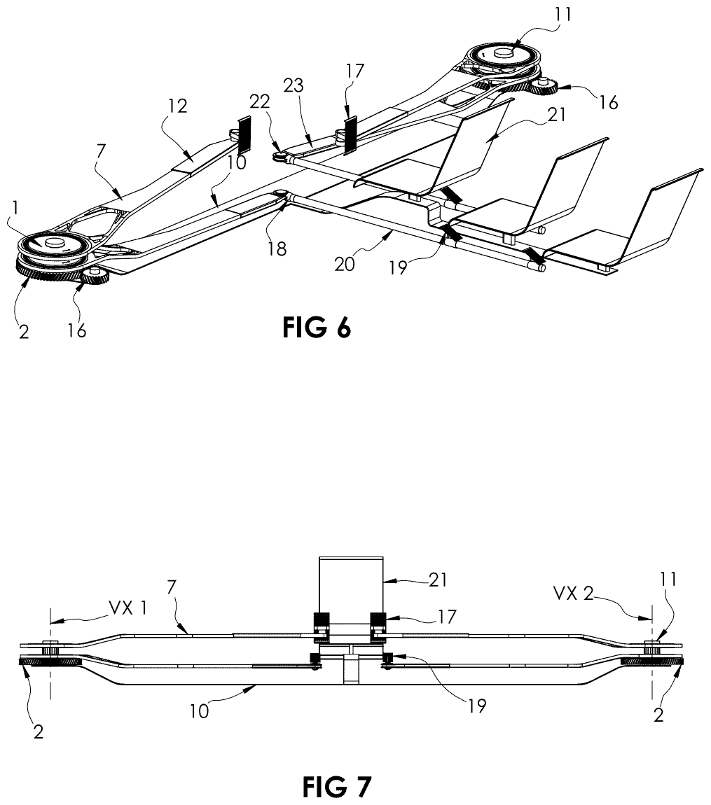

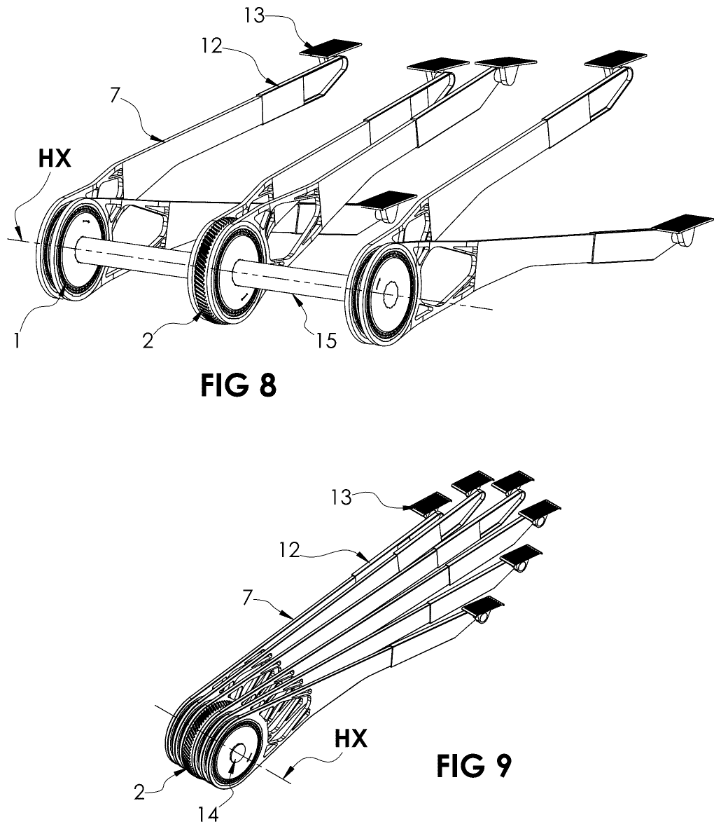

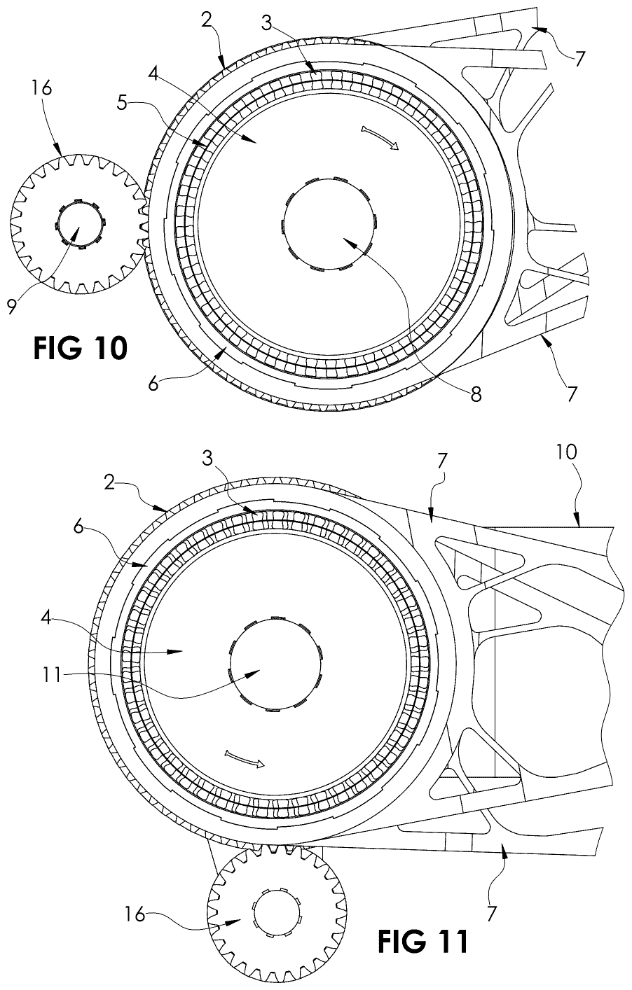

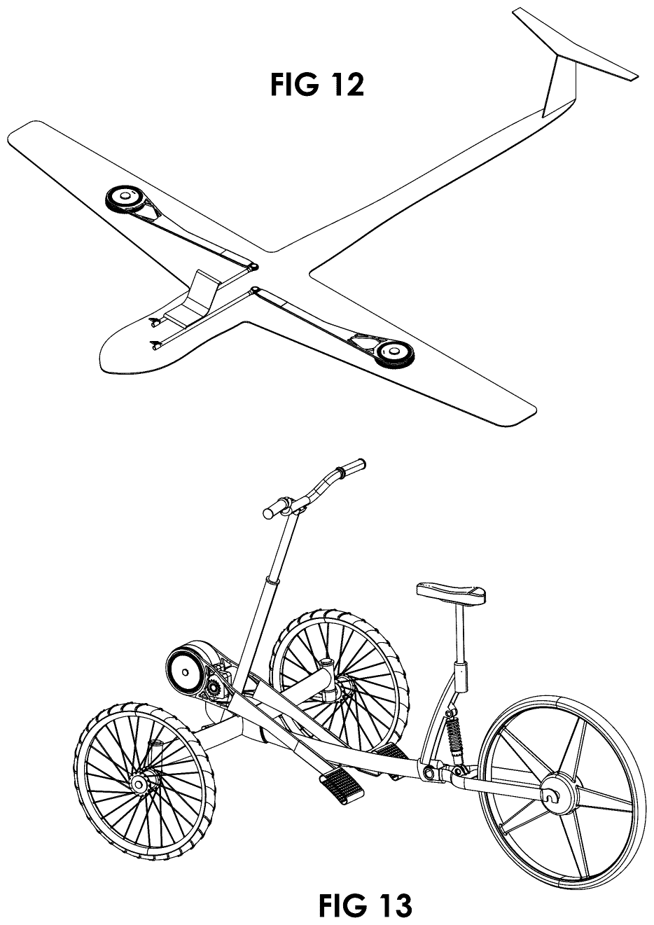

### PRESENTATION OF THE INVENTION AND EMBODIMENT

The present invention relates to a mechanism comprising a frame (10), levers (7), pedals (19,17,13), clutches (01), and/or freewheels, gears and/or pulleys, rotation shafts (8,9, 11, 14, 15), and/or thrust shafts of the levers (20) which convert the reciprocating thrust movement into a rotation movement of the various land vehicles, marine vehicles, gliders, equipment athletes, generators or anything that requires motor force, by the muscular effort of the legs of at least one user in a vertical position (standing) and/or a user in a horizontal position (sitting) or even completely lying on the back or on the stomach in order to push the levers (7) up and down and/or push forward which bounce back and forth less than half a turn around a horizontal axis (HX) and/or two parallel and symmetrical vertical axes (VX1 and VX2), (the two axes *HX1 and HX2* can be inclined at an angle if necessary) where the levers (7) are coupled to the clutches (1) and/or the wheels free (not shown in the figures). In operation, they are maintained in thrust stroke by at least one of the shafts (15,14,11,8) associated with the gears of the guide (2) and/or pulleys (not shown in the figures) or their substitute, but in the return stroke by means of a return spring, or its equivalent having no grip, which results in a continuous rotational movement in one direction. The driving force is directed to the gearbox, drive wheels, propellers, etc., via chains, gears, shafts or belts, depending on the manufacturing needs of the vehicle.

The accompanying figures and protective elements show some methods of manufacturing the mechanism for purposes of clarification, not restriction.

1-8. (canceled)

9. A vehicle propulsion mechanism comprising:
a chassis;
levers,
pedals;
clutches and/or freewheels;
gears and/or pulleys;
rotation shafts;
thrust shafts of the levers which convert the reciprocating thrust movement into a rotation movement of the various land vehicles, marine vehicles, gliders, sports equipment, generators or anything that needs driving force, by the muscular effort of the legs of at least one user in a vertical (standing) position and/or a user in a horizontal sitting position or even completely lying on their back or stomach in order to push the levers up and down and/or push forward which bounce back and forth less than half a turn around a horizontal axis (HX) and/or two vertical axes parallel and symmetrical (VX1 and VX2) (the two axes*HX1 and HX2* can be inclined at an angle if necessary) where the levers are coupled to the clutches and/or the freewheels, and in operation, they are maintained in thrust stroke by at least one of the shafts associated with the gears of the guide and/or pulleys or their substitute, but in the return stroke by means of a return spring, or its equivalent having no grip, which results in a continuous rotational movement in one direction, wherein the driving force is directed to the gearbox, drive wheels, propellers, etc., via chains, gears, shafts or belts, depending on the manufacturing needs of the vehicle.

10. The vehicle propulsion mechanism according to claim 9, wherein due to its silence, its strength and its high torque endurance, the clutch is preferred to the freewheel to operate the mechanism, wherein it consists of a set of solid steel cams and a solid steel wheel in the middle of which there is a toothed hole through which the clutch is coupled to one of rotation shafts and a cage with cam compartment around the steel wheel and a solid steel toothed collar through which the clutch is coupled to the lever.

11. The vehicle propulsion mechanism according to claim 9, wherein the levers and the clutches are connected to the two rotation shafts which rotate around the two parallel and symmetrical vertical axes (VX1 and VX2) where the user pushes the right lever sideways with his right leg and the left lever with his left leg forward then it rebounds by means of a return spring or its equivalent.

12. The vehicle propulsion mechanism according to claim 9, wherein the users who push the two levers connected with the clutch and the rotation shafts which pivot around the two parallel vertical axes and symmetrical (H×1 and H×2) sharing pedals coupled to two push shafts connected to the push shaft supports through a ball joint in one of the mechanism embodiments for the gathering of the driving forces.

13. The vehicle propulsion mechanism according to claim 9, wherein slides the support and/or attaches to the lever to increase or decrease its length, and accordingly, the torque increases by increasing its length, thus increasing the driving force and reducing the effort of the users and vice versa.

14. The vehicle propulsion mechanism according to claim 9, wherein the mechanism with a horizontal axis (HX) which pivots around itself in reciprocating movement using six levers coupled to the clutches and to the shaft where the gear is between a pair among them and the other levers are added in even numbers to the right and left of the gear in one of the embodiments of mechanism for bringing together the driving forces.

15. The vehicle propulsion mechanism according to claim 9, wherein the levers and clutches are coupled to the shaft which rotates around the horizontal axis (HX) and are opposed, parallel and of variable lengths. the two longest levers of them closer to the pinion on its sides and their pedals at the rear and therefore the shortest pedals are at the front, the user in front pushes the two shortest levers and the last pushes the longest of them in one of the ways of realizing the mechanism for collecting the driving forces.

16. The vehicle propulsion mechanism according to claim 9, wherein the levers are attached and fixed jointly with the clutches on one or more of the shafts of even number.
